(19) United States
(12) Patent Application Publication
(10) Pub. No.: US 2025/0188968 A1
(43) Pub. Date: Jun. 12, 2025

(54) CLIP

(71) Applicant: DAIWA KASEI INDUSTRY CO., LTD., Okazaki-shi (JP)

(72) Inventors: Motoki OSAWA, Okazaki-shi (JP); Takahiro SUGIYAMA, Okazaki-shi (JP)

(21) Appl. No.: 18/977,498

(22) Filed: Dec. 11, 2024

(30) Foreign Application Priority Data
Dec. 12, 2023 (JP) 2023-209112
Nov. 29, 2024 (JP) 2024-2082162

(51) Int. Cl. F16B 5/06; F16B 21/07

(52) U.S. Cl. CPC F16B 5/065; F16B 21/075; F16B 5/0664

(57) ABSTRACT

A clip may include a clip main body. The clip main body is configured to be coupled to a coupling portion of an attachment base formed in an attaching article and is configured to be inserted into an attaching hole formed in the object member. The clip main body includes a pair of substantially V-shaped outer legs oppositely positioned in a front-back direction and having head portions and first and second proximal end portions, a pair of inner legs positioned between the pair of outer legs and having head portions and proximal end portions, and a pair of connecting members. The first and second proximal end portions of the outer legs are respectively connected to each other via the connecting members in the front-back direction in such a manner that the outer legs are allowed to flex in the front-back direction. The outer legs respectively include engagement portions configured to engage the attaching hole of the object member.

### CROSS-REFERENCE TO RELATED APPLICATIONS

This application claims priority to Japanese Patent Application Serial No. 2023-209112, filed Dec. 12, 2023, and Japanese Patent Application Serial No. 2024-208216, filed Nov. 29, 2024, the contents of which are incorporated herein by reference.

### BACKGROUND

The present disclosure relates to a clip. More specifically, the present disclosure relates to a clip for detachably attaching an attaching article or component (e.g., an automobile interior part such as a center cluster) to an object member (e.g., an instrument panel).

A known clip is taught by, for example, Japanese Laid-Open Patent Publication No. 2013-44391 (JP2013-44391A). As shown in FIG. 19, the known clip 201 is used for attaching an attaching article, e.g., a center cluster 202, to an object member, e.g., an automobile instrument panel 203. The clip 201 includes a clip main body 201a made of rigid synthetic resin. The clip main body 201a is integrally formed as a unit.

The clip main body 201a of the clip 201 includes a pair of (front and back) substantially V-shaped outer legs 210 oppositely positioned at an interval in a front-back direction, and a pair of (right and left) inner legs 230 (only the right inner leg is shown) positioned between the front and back outer legs 210. The front and back outer legs 210 respectively have head portions 211, and right and left proximal end portions 219 (only the right end portions 219 are shown). The head portions 211 are connected to each other in the front-back direction via a head connecting member 260. The right and left proximal end portions 219 are respectively connected to each other in the front-back direction via right and left proximal end connecting members 240 (the right proximal end connecting member 240 is shown). Thus, the front and back outer legs 210 of the clip main body 201a may be effectively integrated so as not to independently elastically deform or flex in the front-back direction. Further, the outer legs 210 respectively include right and left engagement protrusions 217 (only the right engagement protrusions 217 are shown) formed on the middle portion thereof. The right and left engagement protrusions 217 are respectively shaped so as to have right and left inclined outer engagement surfaces 218 (only the right engagement surfaces 218 are shown). The right and left inner legs 230 are respectively positioned laterally opposite to each other and connected to the right and left proximal end connecting members 240. Further, the right and left inner legs respectively include laterally oppositely projected engagement projections (not shown) that are formed in inner surfaces thereof.

The clip main body 201a is configured to be connected to an attachment base 250 formed in the center cluster 202 by fitting the engagement projections of the right and left inner legs in an engagement slot 252 formed in a plate-shaped coupling portion 251 of the attachment base 250. Further, the clip main body 201a is configured to be introduced into an attaching hole 203a formed in the instrument panel 203 while flexing the front and back outer legs 210 laterally inward in a condition in which the clip main body 201a is connected to the attachment base 250 formed in the center cluster 202.

In order to attach the center cluster 202 to the instrument panel 203, first, the clip main body 201a of the clip 201 is connected to the attachment base 250 formed in the center cluster 202 by fitting the engagement projections of the right and left inner legs 230 in the engagement slot 252 formed in the coupling portion 251 of the attachment base 250. Thereafter, the clip main body 201a connected to the attachment base 250 formed in the center cluster 202 is pressed into the attaching hole 203a of the instrument panel 203 until the engagement surfaces 218 of the engagement protrusions 217 formed in the front and back outer legs 210 contact or engage an inner (upper) periphery (not labeled) of the attaching hole 203a of the instrument panel 203. Thus, the center cluster 202 is attached to the instrument panel 203 via the clip 201. Further, the center cluster 202 attached to the instrument panel 203 can be easily removed from the instrument panel 203 by simply pulling out the clip main body 201a from the attaching hole 203a as necessary.

However, in a condition in which the center cluster 202 is attached to the instrument panel 203 using the clip 201 (i.e., in a normal use condition of the clip 201), the center cluster 202 and the instrument panel 203 may sometimes be inclined relative to each other (FIG. 9). In such a case, the clip main body 201a may be inclined relative to the instrument panel 203 (which may be referred to as an inclined use condition of the clip 201). As a result, the front and back outer legs 210 may be inclined relative to the instrument panel 203, so that engagement positions of the engagement protrusions 217 (the engagement surfaces 218) with the inner periphery of the attaching hole 203a of the instrument panel 203 may be obliquely moved or displaced upward. Further, the front and back outer legs 210 cannot flex or move relative to each other because the head portions 211 of the front and back outer legs 210 are connected to each other via the head connecting member 260. As a result, displacement of the engagement positions of the engagement surfaces 218 with the inner periphery of the attaching hole 203a cannot be controlled or compensated. Therefore, due to the displacement of the engagement positions of the engagement protrusions 217 with the inner periphery of the attaching hole 203a, engagement amounts of the engagement surfaces 218 with the inner periphery of the attaching hole 203a of the instrument panel 203 may be considerably reduced, thereby considerably reducing engagement forces of the engagement protrusions 217 against the attaching hole 203a of the instrument panel 203. As a result, a retention force of the clip 201 in the inclined use condition of the clip 201 (which may be referred to as an oblique retention force of the clip 201) may be considerably reduced relative to a retention force of the clip 201 in the normal use condition of the clip 201 (which may be referred to as a normal retention force of the clip 201). Generally, the oblique retention force of the clip 201 may be reduced at a reduction rate of approximately 45% relative to the normal retention force of the clip 201. Therefore, in a condition in which the clip main body 201a is inclined relative to the instrument panel 203 (the attaching hole 203a), the center cluster 202 cannot be reliably held on the instrument panel 203 via the clip 201.

Thus, there is a need in the art for improved clips

### SUMMARY

For example, in one aspect of the present disclosure, a clip may include a clip main body. The clip main body is configured to be coupled to a coupling portion of an attachment base formed in an attaching article and is configured to be inserted into an attaching hole formed in the object member. The clip main body include a pair of substantially V-shaped outer legs oppositely positioned in a front-back direction and having head portions and first and second proximal end portions, a pair of inner legs positioned between the pair of outer legs and having head portions and proximal end portions, and a pair of connecting members. The first and second proximal end portions of the outer legs are respectively connected to each other via the connecting members in the front-back direction in such a manner that the outer legs are allowed to flex relative to each other in the front-back direction. The proximal end portions of the inner legs are respectively connected to the connecting members such that the inner legs are positioned laterally opposite to each other. The outer legs respectively include engagement portions configured to engage the attaching hole of the object member. The inner legs respectively include engagement projections configured to be coupled to the coupling portion of the attachment base.

According to the aspect of the present disclosure, in a condition in which the clip main body is inserted into the attaching hole, when the clip main body is inclined relative to the attaching hole, engagement positions of the engagement portions of the outer legs with the attaching hole may be moved or displaced. However, the front and back outer legs are configured to flex relative to each other in the front-back direction. Therefore, the engagement portions of the outer legs may move or slide along periphery of the attaching hole while elastically flexing or deforming the outer legs relative to each other in the front-back direction. Thus, displacement of the engagement positions of the engagement portions with the attaching hole may be controlled or compensated. Therefore, engagement amounts of the engagement portions with the attaching hole may be prevented from being significantly changed or reduced. That is, engagement forces of the engagement portions against the attaching hole may be prevented from being significantly reduced. As a result, a retention force of the clip may substantially be maintained.

Other objects, features and advantages of the present disclosure will be readily understood after reading the following detailed description together with the accompanying drawings and the claims.

### BRIEF DESCRIPTION OF THE DRAWINGS

FIG. 1 is a perspective view of a clip according to a first embodiment, an attaching article and an object member, which illustrates a condition before the attaching article is attached to the object member using the clip;

FIG. 2 is an enlarged perspective view of the clip;

FIG. 3 is an enlarged elevational view of the clip shown in FIG. 2;

FIG. 4 is an enlarged side view of the clip shown in FIG. 2;

FIG. 5 is an enlarged plan view of the clip shown in FIG. 2;

FIG. 6 is a schematic elevational view of the clip, which illustrates a condition in which the clip connected to the attachment base of the attaching article is being inserted into an attaching hole formed in the object member;

FIG. 7 is a schematic elevational view of the clip, which illustrates a condition in which the clip connected to the attachment base of the attaching article is completely inserted into the attaching hole of the object member, thereby attaching the attaching article to the object member;

FIG. 8 is a schematic side view of FIG. 7;

FIG. 9 is a schematic side view similar to FIG. 8, which illustrate a condition in which the attaching article is inclined relative to the object member;

FIG. 10 is a perspective view of a clip according to a second embodiment, the attaching article and the object member, which illustrates a condition before the attaching article is attached to the object member using the clip;

FIG. 11 is an enlarged perspective view of the clip;

FIG. 12 is an enlarged elevational view of the clip shown in FIG. 11;

FIG. 13 is an enlarged side view of the clip shown in FIG. 11;

FIG. 14 is an enlarged plan view of the clip shown in FIG. 11;

FIG. 15 is a schematic elevational view of the clip, which illustrates a condition in which the clip connected to the attachment base of the attaching article is being inserted into the attaching hole formed in the object member;

FIG. 16 is a schematic elevational view of the clip, which illustrates a condition in which the clip connected to the attachment base of the attaching article is completely inserted into the attaching hole of the object member, thereby attaching the attaching article to the object member;

FIG. 17 is a schematic side view of FIG. 16;

FIG. 18 is a schematic side view similar to FIG. 17, which illustrate a condition in which the attaching article is inclined relative to the object member; and

FIG. 19 is a schematic side view of a conventional clip, which illustrates a condition in which an attaching article is attached to an object member using the clip and in which the attaching article is inclined relative to the object member.

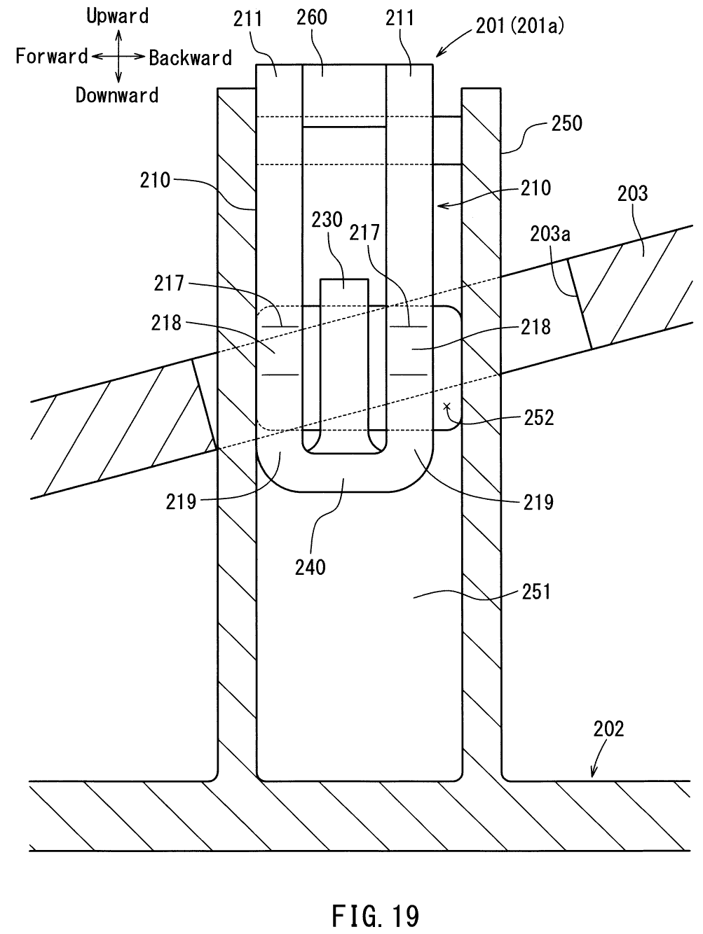

### DETAILED DESCRIPTION

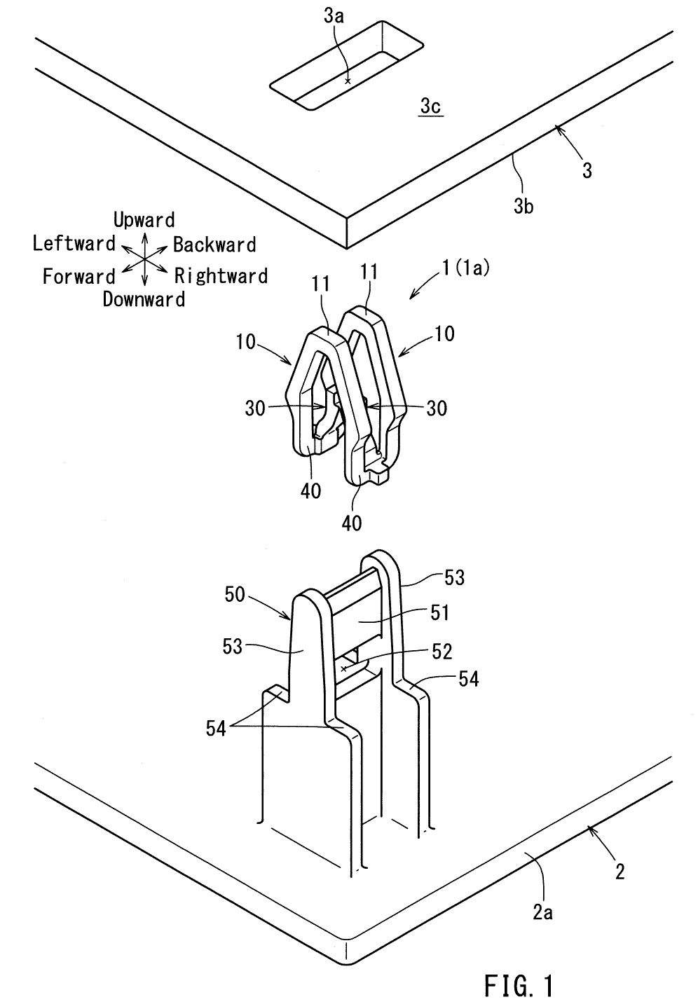

Detailed representative embodiments of the present disclosure are shown in FIGS. 1 to 18.

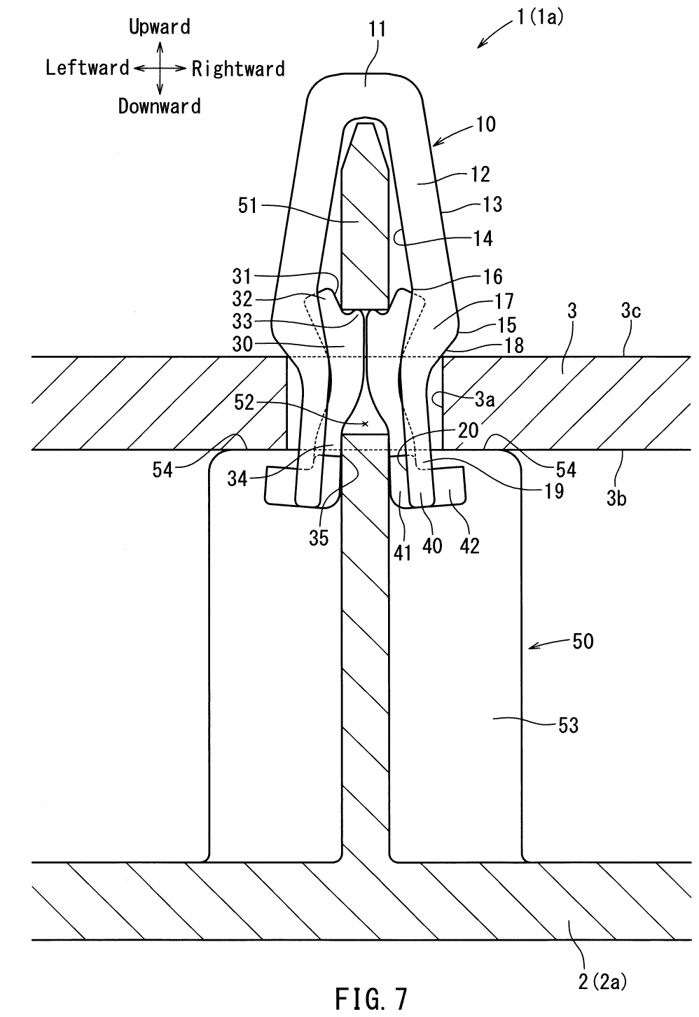

A first detailed representative embodiment of the present disclosure will be described with reference to FIGS. 1 to 9. As shown in FIG. 1, the first embodiment is directed to a clip 1 that is used for detachably attaching an attaching article 2 (e.g., an interior part such as an ornament panel) to an object member 3 (e.g., an instrument panel) having an outer surface 3b and an inner surface 3c. The clip 1 is configured to be connected to an attachment base 50 formed in a rear (inner) surface of an article main body 2a of the attaching article 2. In particular, the clip 1 is configured to be coupled to a plate-shaped coupling portion 51 formed as a portion of the attachment base 50 and having an engagement slot 52, so as to be connected to the attachment base 50 of the attaching article 2. Further, the clip 1 is configured to be inserted into an attaching hole 3a formed in the object member 3 and having an elongated rectangular shape. Upon insertion of the clip 1 into the attaching hole 3a after the clip 1 is connected to the attachment base 50 of the attaching article 2, the attaching article 2 can be attached to the object member 3 via the clip 1 (FIG. 7). As will be recognized, a plurality of clips, a plurality of attaching bases and a plurality of attaching holes are generally used in order to attach the attaching article 2 to the object member 3. However, one of them (i.e., the clip 1, the attachment base 50 and the attaching hole 3a) may be described in this description because they have the same structure as each other.

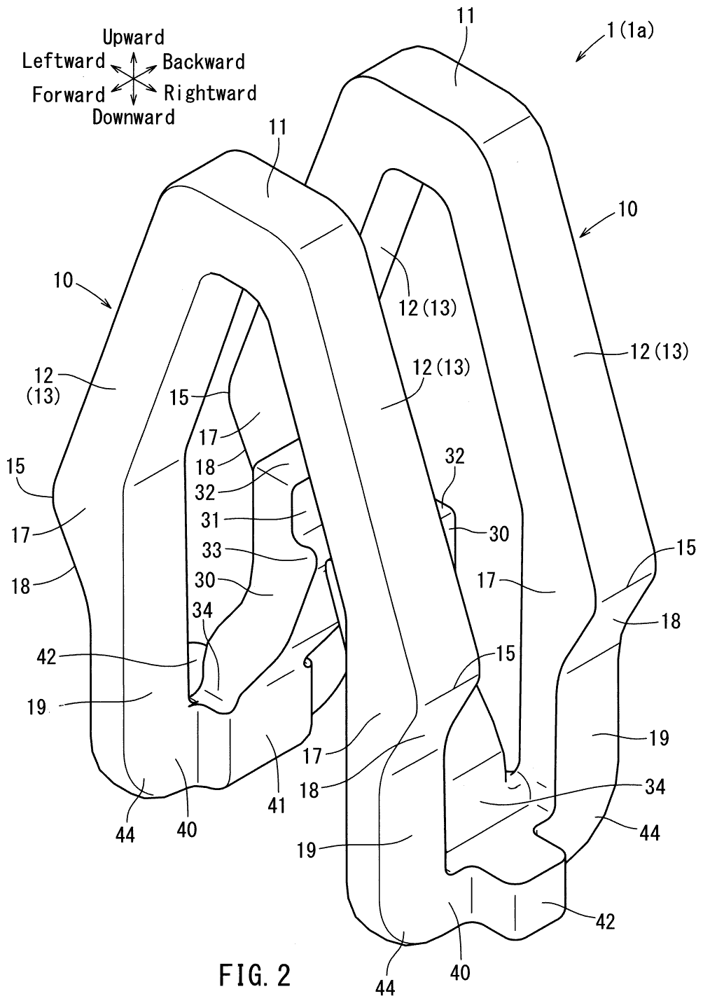

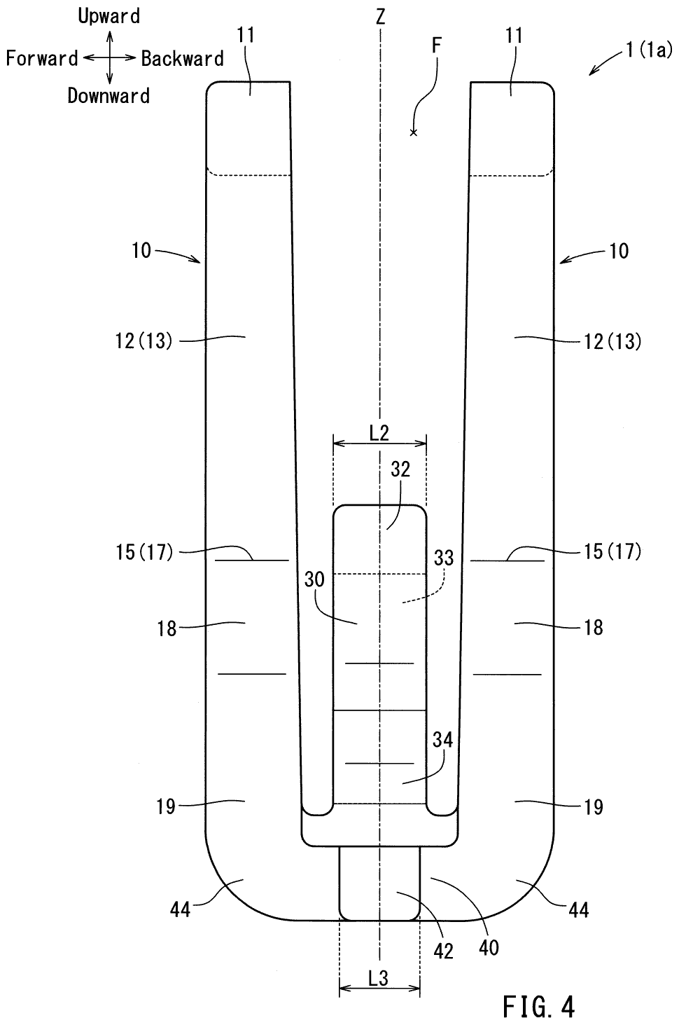

As shown in FIGS. 2 to 5, the clip 1 includes a clip main body 1a made of rigid synthetic resin, e.g., polypropylene (PP). The clip main body 1a may preferably be integrally molded as a unit. As shown in FIG. 4, the clip main body 1a includes a pair of (front and back) substantially V-shaped engagement members or outer legs 10, a pair of (right and left) retainer members or inner legs 30, and a pair of connecting members 40. The outer legs 10 are separately and oppositely positioned at an interval in a front-back direction, thereby forming a space F therebetween. The space F is configured to allow the outer legs 10 to elastically flex or move relative to each other in the front-back direction.

The outer legs 10 respectively have rounded head portions 11, and leg main portions 12 respectively laterally obliquely extending outward from the head portions 11 and having root portions 19. The head portions 11 are configured to function as a leading end of the clip 1 when the clip 1 is inserted into the attaching hole 3a of the object member 3. The leg main portions 12 are configured to flex on the head portions 11 in a lateral direction (right and left). Further, the root portions 19 of the leg main portions 12 positioned on the right and left sides of the outer legs 10 may respectively be referred to as first and second (right and left) proximal end portions of the outer legs 10.

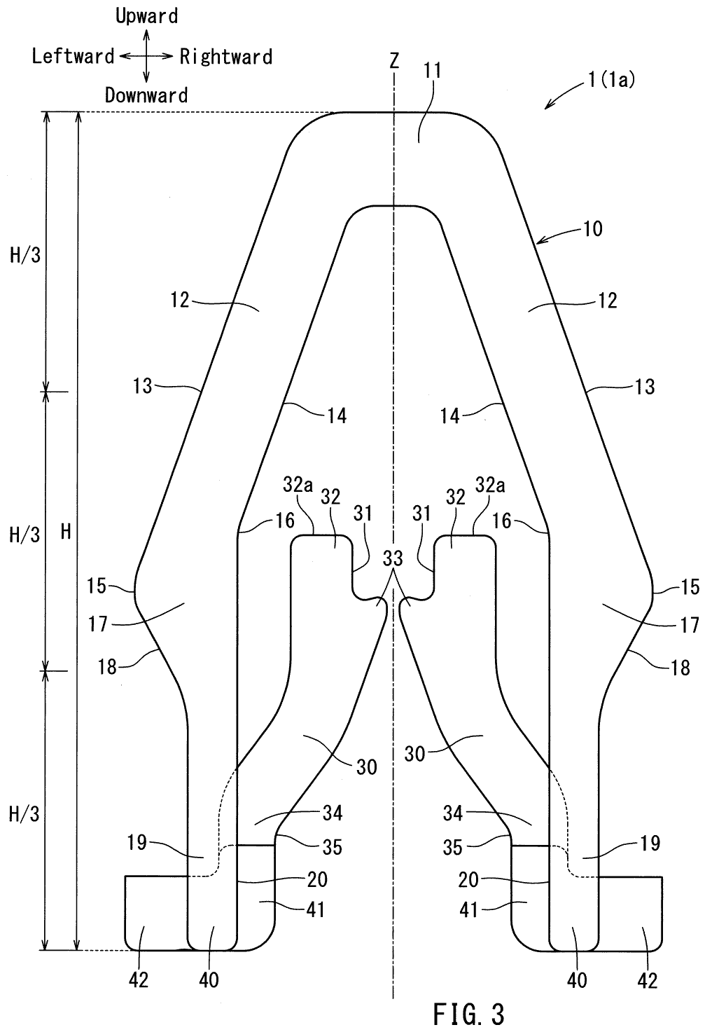

As shown in FIG. 3, the leg main portions 12 have outer surfaces 13 and inner surfaces 14 that are inclined outward. The outer surfaces 13 (which may be referred to as outer surfaces of the outer legs 10) are configured to contact an outer surface-side periphery (not labeled) of the attaching hole 3a of the object member 3 when the clip 1 is inserted into the attaching hole 3a, thereby gradually flexing the leg main portions 12. Further, the leg main portions 12 are bent inward in the middle thereof, thereby forming bent portions thereon. The bent portions are formed into bulged or thickened engagement portions 17. The engagement portions 17 are specially shaped so as to have downward-facing engagement surfaces 18 that are capable of engaging an inner surface-side periphery (not labeled) of the attaching hole 3a. In particular, the inner surfaces 14 of the leg main portions 12 are gently curved inward at inner bent portions 16, and linearly extend to the root portions 19 from the inner bent portions 16. Further, the outer surfaces 13 of the leg main portions 12 are greatly curved inward at outer bent portions 15 positioned below the inner bent portions 16, thereby forming downward-facing surfaces therein. Thereafter, the outer surfaces 13 linearly extend to the root portions 19 while turning slightly outward. The downward-facing surfaces formed in the outer surfaces 13 may correspond to the engagement surfaces 18. Thus, the engagement portions 17 having the engagement surfaces 18 may be formed in the leg main portions 12 between the inner bent portions 16 and the outer bent portions 15.

As shown in FIG. 2, the outer legs 10 are connected to each other via the connecting members 40 at the right proximal portions and the left proximal portions thereof. In particular, the root portions 19 of the leg main portions 12 positioned on the right side and the left side of the outer legs 10 are respectively connected to each other via the connecting members 40 in the front-back direction in such a manner that the outer legs 10 are allowed to freely flex in the front-back direction. Further, the connecting members 40 respectively have inner projections 41 and outer projections 42 formed in their longitudinal central portions. The inner projections 41 are configured to project laterally inward from the connecting members 40. Conversely, the outer projections 42 are configured to project laterally outward from the connecting members 40.

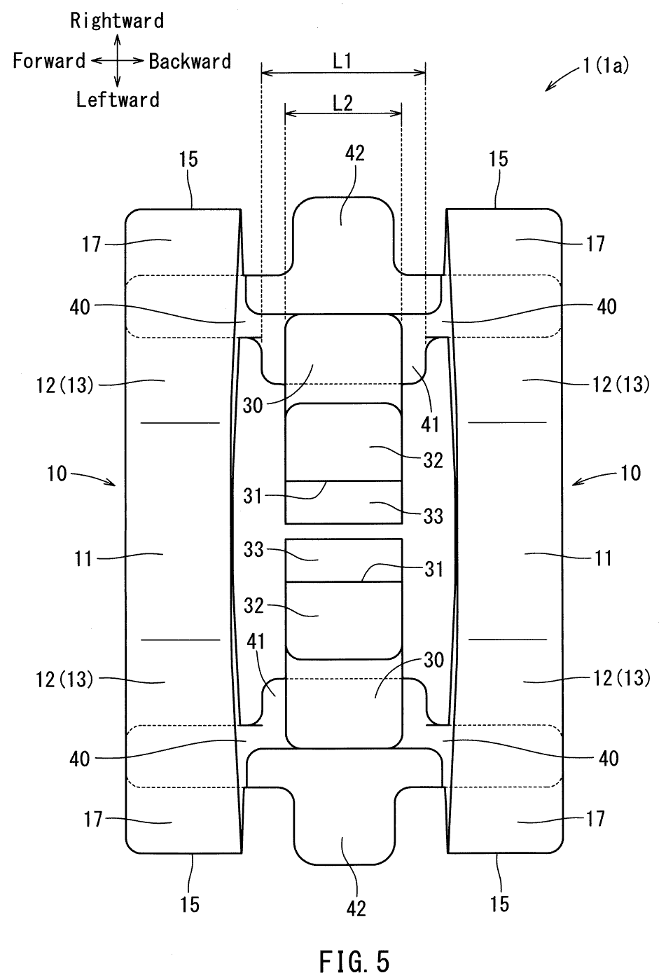

The inner legs 30 are positioned between the front and back outer legs 10. The inner legs 30 respectively have proximal end portions 34 and distal end or head portions 32. As shown in FIG. 3, the inner legs 30 are positioned laterally opposite to each other while the proximal end portions 34 of the inner legs 30 are connected to the inner projections 41 of the connecting members 40. Thus, the inner legs 30 are integrated with the connecting members 40 in the form of cantilever arms. Further, the inner legs 30 respectively include engagement projections 33 formed in inner surfaces 31 thereof and positioned adjacent to the head portions 32. The engagement projections 33 are configured to engage the engagement slot 52 formed in the coupling portion 51 of the attachment base 50. Further, as shown in FIG. 5, the inner projections 41 may preferably have widths L1 greater than widths L2 of the inner legs 30, so as to reliably support the proximal end portions 34 of the inner legs 30 connected thereto.

The inner legs 30 are preferably oppositely positioned such that a distance between the engagement projections 33 may be equal to or slightly smaller than a thickness of the coupling portion 51 of the attachment base 50 formed in the attaching article 2. Further, as described above, the proximal end portions 34 of the inner legs 30 are connected to the inner projections 41 formed in the connecting members 40. Therefore, as shown in FIG. 3, the proximal end portions 34 of the inner legs 30 are positioned such that inner surfaces 35 thereof are projected inward (toward an axial line Z of the clip main body 1a) relative to inside faces 20 of the root portions 19 of the leg main portions 12 (the proximal portions of the outer legs 10). Further, the proximal end portions 34 of the inner legs 30 are configured such that a distance therebetween may be sufficiently greater than the thickness of the coupling portion 51 of the attachment base 50. This means that the inner legs 30 are configured such that a distance therebetween may be gradually reduced from the proximal end portions 34 toward the engagement projections 33 (FIG. 3). Therefore, the clip 1 (the clip main body 1a) can be quickly and easily coupled to the coupling portion 51 of the attachment base 50 formed in the attaching article 2 because the coupling portion 51 can be smoothly introduced between the inner legs 30. Further, the inner legs 30 are configured to be deformed due to increase in temperature of the clip 1 such that the head portions 32 may be laterally away from each other.

As previously described, the connecting members 40 include the outer projections 42. The outer projections 42 may function to prevent the clip 1 from passing through the attaching hole 3a of the object member 3 in a condition in which the clip 1 coupled to the coupling portion 51 of the attachment base 50 formed in the attaching article 2 is inserted into the attaching hole 3a of the object member 3. Further, as shown in FIG. 4, the outer projections 42 preferably have widths L3 substantially equal to the widths L2 of the inner legs 30. This may contribute to increased moldability of the clip 1.

As shown in FIG. 4, the connecting members 40 respectively have (front and back) rounded portions 44 formed in front and back ends thereof and facing in the front-back direction. The rounded portions 44 may contribute to increased workability of the clip 1. That is, when the clip main body 1a is pressed to the coupling portion 51 of the attachment base 50 formed in the attaching article 2 in order to connect the clip main body 1a to the attachment base 50, even if the front and back ends of the connecting members 40 interfere with a portion of the attachment base 50, the clip main body 1a can be smoothly connected to the attachment body 50.

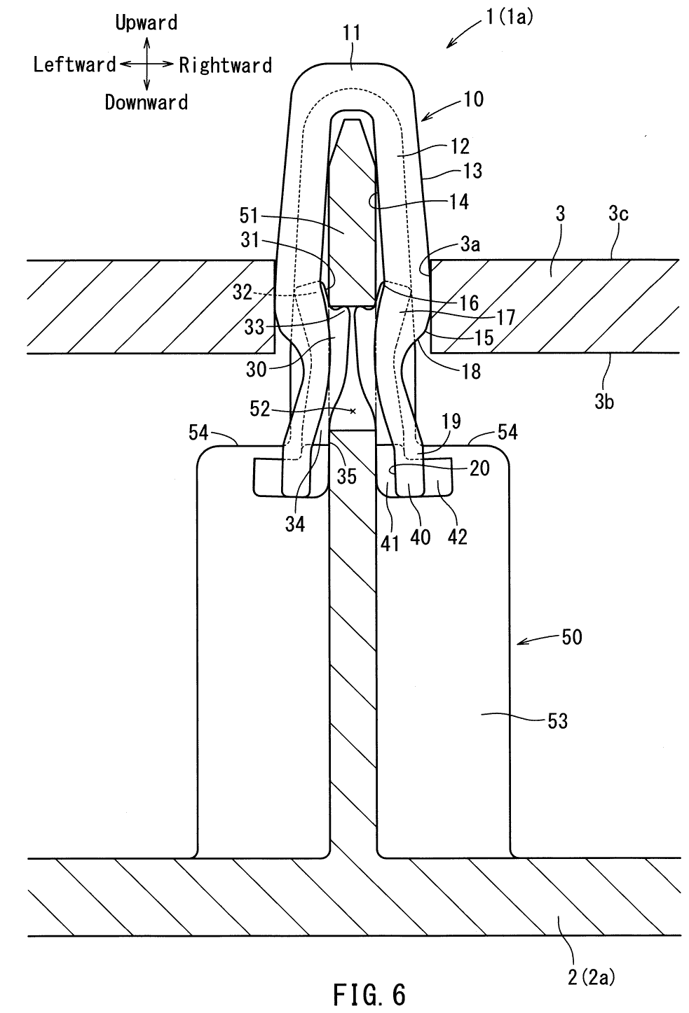

As previously described, the attaching article 2 includes the article main body 2a, the attaching base 50 formed in the rear (inner) surface of the article main body 2a. The attachment base 50 includes the coupling portion 51 having the engagement slot 52 formed therein. The coupling portion 51 is shaped such that its distal end (not labeled) has a wedge shape. Further, the attachment base 50 includes a pair of guide portions 53 that are respectively positioned on widthwise opposite end peripheries of the coupling portions 51. The guide portions 53 may function to guide the outer legs 10 when the clip main body 1a is pressed to the coupling portions 51. Further, the guide portions 53 respectively include shouldered or widened stopper portions 54 formed therein. The stopper portions 54 are configured to contact the outer surface 3b of the object member 3 when the clip 1 coupled to the coupling portions 51 of the attachment base 50 formed in the article main body 2a is inserted into the attaching hole 3a of the object member 3 (FIG. 6).

Next, a method of attaching the attaching article 2 to the object member 3 using the clip 1 and detaching the attaching article 2 from the object member 3 will now be described in detail with reference to FIGS. 6 and 7.

First, the clip main body 1a is pressed to the coupling portion 51 of the attachment base 50 formed in the attaching article 2 in such a manner that the inner legs 30 may be positioned on both sides of the coupling portion 51 with the engagement projections 33 engaging the engagement slot 52 formed in the coupling portion 51. As a result, the clip main body 1a is coupled to the coupling portion 51 of the attachment base 50. Thus, the clip main body 1a can be connected to the attachment base 50 of the attaching article 2.

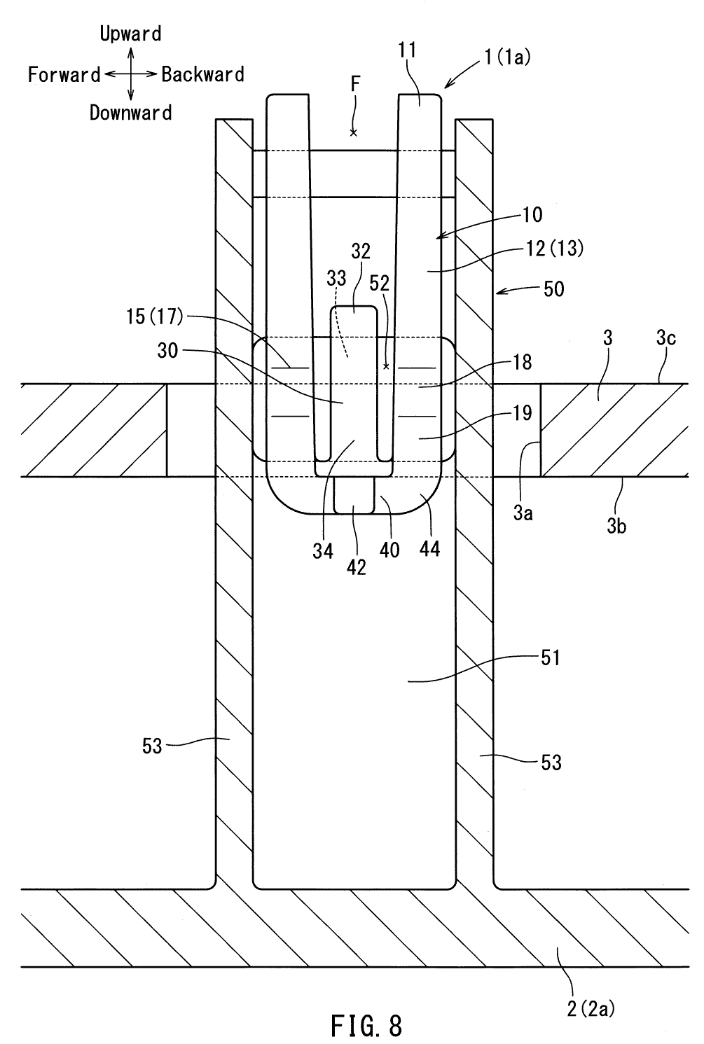

Thereafter, the clip main body 1a connected to the attachment base 50 of the attaching article 2 is pushed into the attaching hole 3a formed in the object member 3 at the head portions 11 of the outer legs 10. As a result, as shown in FIG. 6, the clip main body 1a may be progressively inserted into the attaching hole 3a while the leg main portions 12 of the outer legs 10 are elastically flexed inward due to contact of the outer surfaces 13 of the leg main portions 12 with the outer surface-side periphery (not labeled) of the attaching hole 3a. Subsequently, when the clip main body 1a is further pushed into the attaching hole 3a until the stopper portions 54 formed in the guide portions 53 of the attaching base 50 contact the outer surface 3b of the object member 3, the engagement portions 17 formed in the leg main portions 12 pass through the attaching hole 3a. As a result, as shown in FIG. 7, the leg main portions 12 of the outer legs 10 can be gradually restored or flexed outward, so that the engagement surfaces 18 of the engagement portions 17 may elastically engage the inner surface-side periphery (not labeled) of the attaching hole 3a due to elastic forces of the leg main portions 12 (the outer legs 10). Upon engagement of the engagement surface 18 with the attaching hole 3a, the clip main body 1a may be held in the attaching hole 3a. That is, the clip main body 1a may be connected to the object member 3. Thus, the attaching article 2 may be attached to the object member 3 via the clip main body 1a, which may be referred to as a normal use condition of the clip 1 (FIGS. 7 and 8).

Further, as shown in FIG. 7, in the normal use condition of the clip 1, the inner projections 41 formed in the connecting members 40 may be pressed to the coupling portion 51 of the attachment base 50. Therefore, the inner legs 30 may be prevented from being excessively deformed. As a result, the clip main body 1a may be reliably held in the attaching hole 3a, so that the attaching article 2 may be securely attached to the object member 3.

Conversely, in order to detach or remove the attaching article 2 from the object member 3, the attaching article 2 is simply pulled such that a certain degree of extraction force can be applied to the clip main body 1a. When such an extraction force is applied to the clip main body 1a, the clip main body 1a may be withdrawn from the attaching hole 3a. As a result, the attaching article 2 can be removed from the object member 3. Thus, the attaching article 2 can be easily attached to and detached from the object member 3.

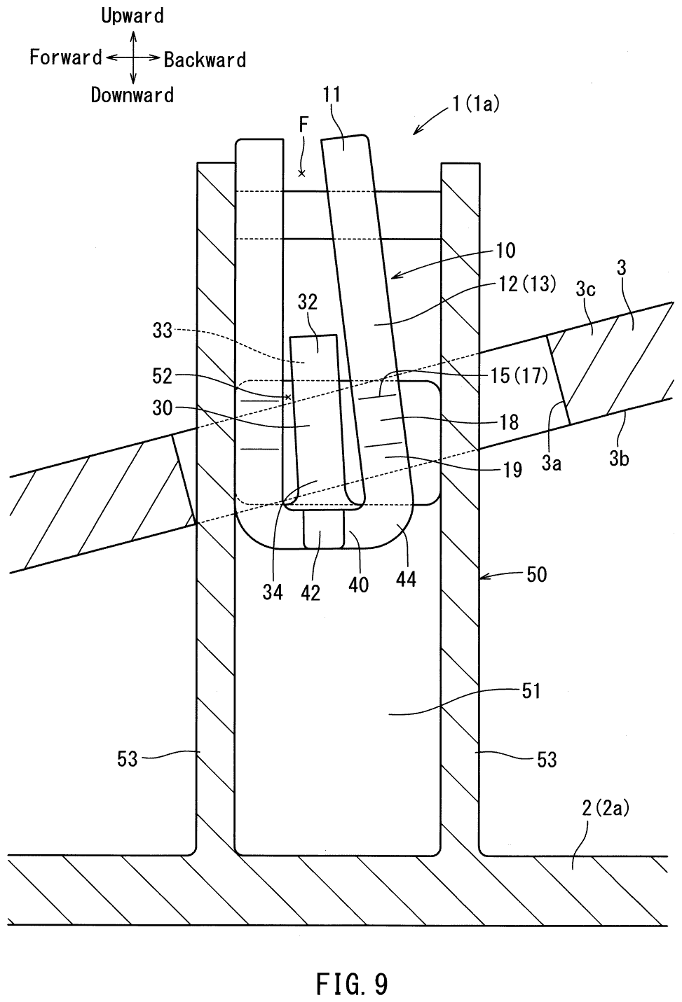

As shown in FIG. 8, in a condition in which the attaching article 2 is attached to the object member 3 using the clip main body 1a (i.e., in the normal use condition of the clip 1), the attaching article 2 (the attachment base 50) and the object member 3 may sometimes be inclined relative to each other in the front-back direction. As shown in FIG. 9, when the attaching article 2 is inclined relative to the object member 3, the clip main body 1a may be inclined relative to the object member 3 (which may be referred to as an inclined use condition of the clip 1). Consequently, the front and back outer legs 10 may be inclined relative to the attaching hole 3a, so that engagement positions of the engagement surfaces 18 of the engagement portions 17 with the inner surface-side periphery (not labeled) of the attaching hole 3a may substantially be obliquely moved or displaced upward. However, in the clip main body 1a, the head portions 11 of the front and back outer legs 10 are not connected to each other. That is, the clip main body 1a is configured such that the front and back outer legs 10 may freely elastically flex within the space F in the front-back direction independently from each other. Therefore, as shown in FIG. 9, when the clip main body 1a is inclined relative to the object member 3, the engagement surfaces 18 of the engagement portions 17 of one of the outer legs 10 may move or slide along the inner surface-side periphery of the attaching hole 3a of the object member 3 while elastically flexing or deforming one of the outer legs 10 relative to the other of the outer legs 10 in the front-back direction.

As a result, displacement of the engagement positions of the engagement surfaces 18 with the inner surface-side periphery (not labeled) of the attaching hole 3a may substantially be controlled or compensated. Therefore, engagement amounts of the engagement surfaces 18 with the inner surface-side periphery of the attaching hole 3a may be prevented from being significantly changed or reduced. That is, engagement forces of the engagement surfaces 18 against the inner surface-side periphery of the attaching hole 3a may be prevented from being significantly reduced. As a result, a retention force of the clip 1 in the inclined use condition of the clip 1 (which may be referred to as an oblique retention force of the clip 1) may be prevented from being significantly reduced relative to a retention force of the clip 1 in the normal use condition of the clip 1 (which may be referred to as a normal retention force of the clip 1), so as to fall within an allowable range. In this embodiment, the oblique retention force of the clip 1 may be reduced at a reduction rate of approximately 20% relative to the normal retention force of the clip 1. Therefore, the attaching article 2 can be reliably held on the object member 3 via the clip 1 even if the attaching article 2 (the clip main body 1a) is inclined relative to the object member 3.

Further, in the inclined use condition of the clip 1, when one of the outer legs 10 elastically flex relative to the other of the outer legs 10, one of the outer legs 10 may interfere with the inner legs 30. This may contribute to increase of the oblique retention force of the clip 1.

Further, as shown in FIG. 6, when the clip main body 1a is pushed into the attaching hole 3a of the object member 3, the outer legs 10 may be elastically flexed inward by the attaching hole 3a so as to be overlapped with the inner legs 30 in the front-back direction. Therefore, the outer legs 10 can smoothly pass through the attaching hole 3a of the object member 3.

Further, as shown in FIG. 7, the inner legs 30 are preferably configured such that in the normal use condition of the clip 1, the distal end portions (the head portions 32) thereof may be positioned inside (i.e., positioned on the side of the axial line Z) relative to the outer surfaces 13 of the leg main portions 12 of the outer legs 10. According to the structure, even when the clip main body 1a is plastically deformed due to thermal creep deformation in the normal use condition of the clip 1, such a deformed clip main body 1a may be used again with no difficulty because when the deformed clip main body 1a is inserted into the attaching hole 3a of the object member 3, the distal end portions of the inner legs 30 do not interfere with the outer surface-side periphery of the attaching hole 3a.

Further, as shown in FIG. 3, the inner legs 30 are generally configured such that heights of their upper surfaces 32a above lower end surfaces (not labeled) of the outer legs 10 may be from ⅓ (one-third) to ⅔ (two-thirds) of an overall height H of the outer legs 10. Naturally, the inner legs 30 may be variously modified in shape and size as necessary.

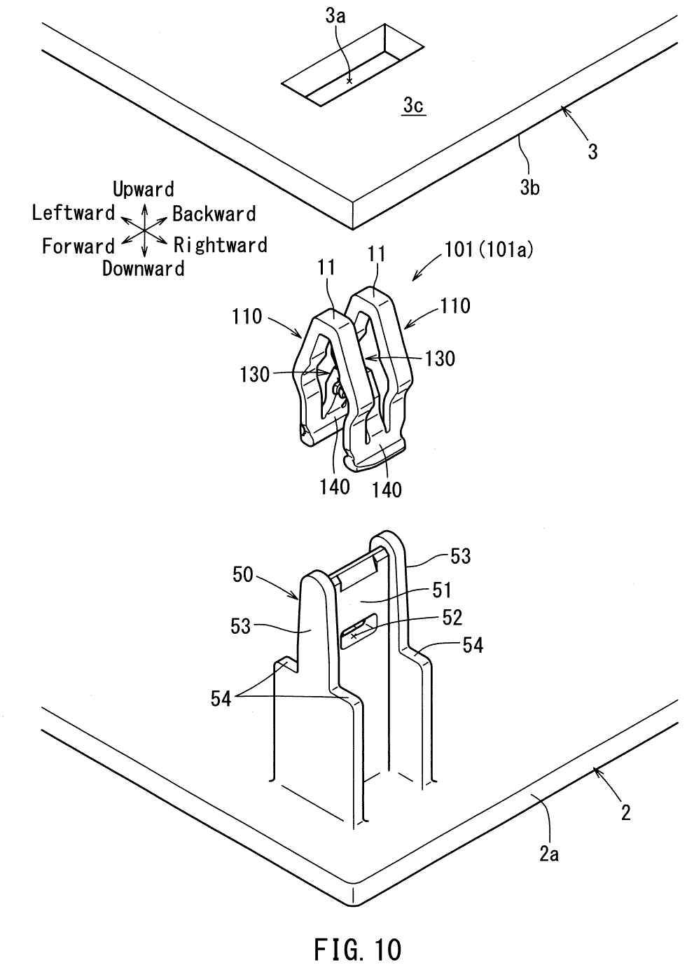

A second detailed representative embodiment of the present disclosure will be described with reference to FIGS. 10 to 18. Further, because the second embodiment relates to the first embodiment, only the constructions and elements that are different from the first embodiment will be explained in detail. Elements that are the same in the first and second embodiments will be identified by the same reference numerals and a detailed description of such elements may be omitted or simplified.

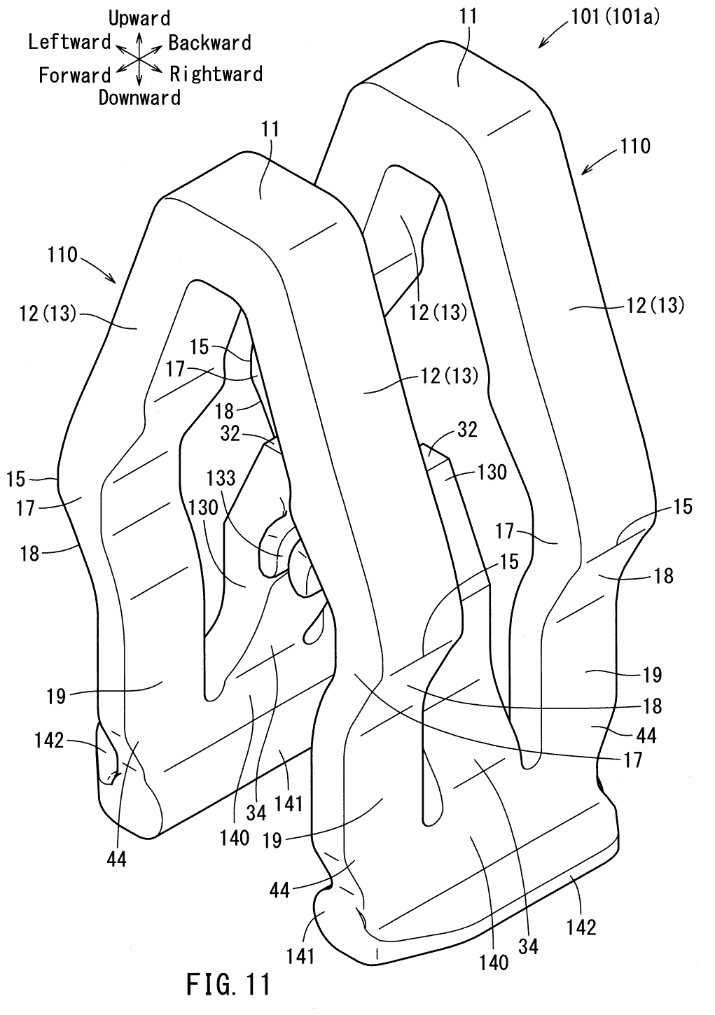

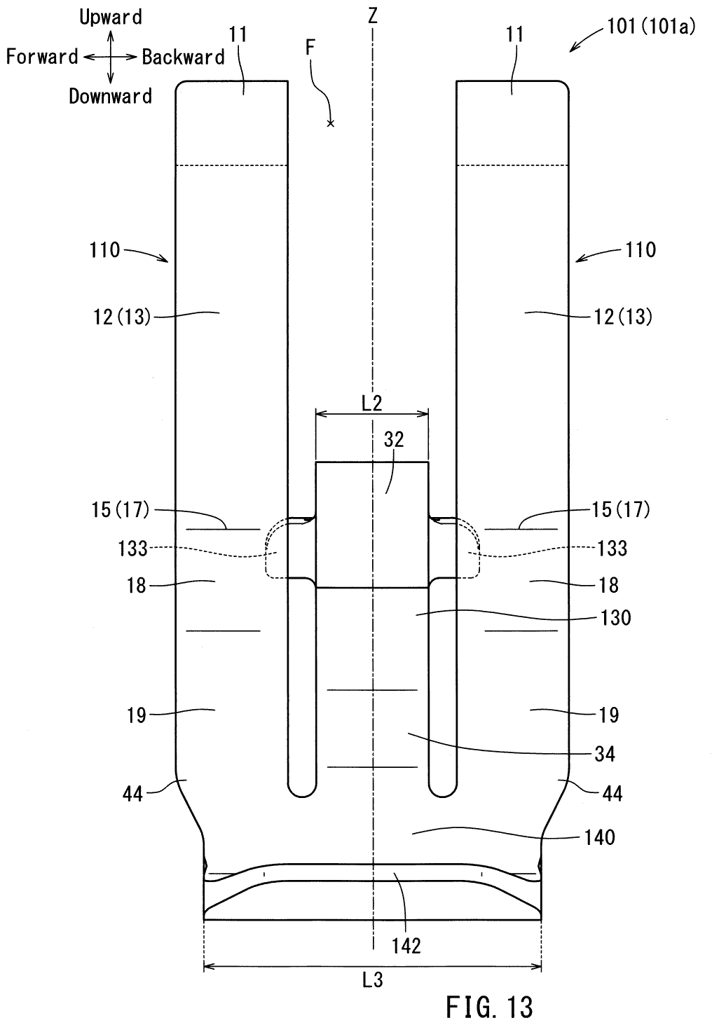

As shown in FIG. 10, the second embodiment is directed to a clip 101. Similar to the clip 1 of the first embodiment, the clip 101 is used for detachably attaching the attaching article 2 to the object member 3 having the outer surface 3b and the inner surface 3c. As shown in FIGS. 11 to 14, the clip 101 includes a clip main body 101a. As shown in FIG. 13, the clip main body 101a includes a pair of (front and back) outer legs 110, a pair of (right and left) inner legs 130, and a pair of connecting members 140.

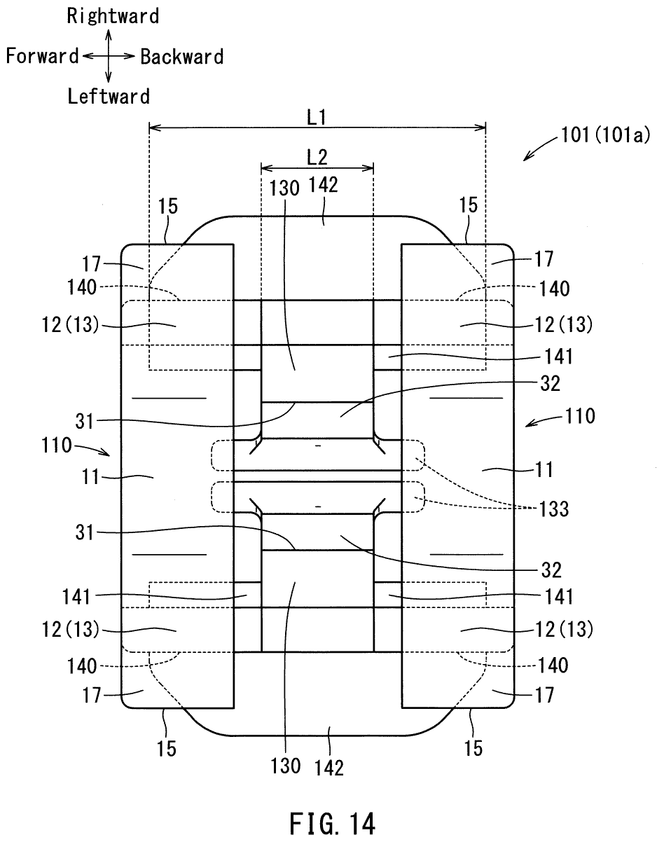

The outer legs 110 respectively have the substantially same structure as the outer legs 10 of the first embodiment. Similar to the first embodiment, the outer legs 110 are connected to each other via the connecting members 140 at the right proximal portions and the left proximal portions thereof. Further, similar to the connecting members 40 of the first embodiment, the connecting members 140 respectively have inner projections 141 and outer projections 142 corresponding to the inner projections 41 and the outer projections 42 of the first embodiment. However, unlike the inner projections 41 of the first embodiment, the inner projections 141 are configured to extend over the entire length of the connecting members 140. That is, as shown in FIG. 14, the inner projections 141 may preferably have widths L1 greater than widths L2 of the inner legs 130. Similarly, unlike the outer projections 42 of the first embodiment, the outer projections 142 are configured to extend over the entire length of the connecting members 140. That is, as shown in FIG. 13, the outer projections 142 have widths L3 greater than the widths L2 of the inner legs 130.

The inner legs 130 respectively have the substantially same structure as the inner legs 30 of the first embodiment. However, unlike the first embodiment, the head portions 32 are slightly modified. In particular, in this embodiment, the head portions 32 include oblique outer surfaces 32b continuously extending from the upper surfaces 32a and inclined downward and outward. Further, the inner legs 130 respectively include engagement projections 133 instead of the engagement projections 33 of the first embodiment. As shown in FIGS. 11 and 13, the engagement projections 133 are slightly different from the engagement projections 33 in that the engagement projections 133 are elongated in the front-back direction so as to be projected from the inner legs 130 in the front-back direction.

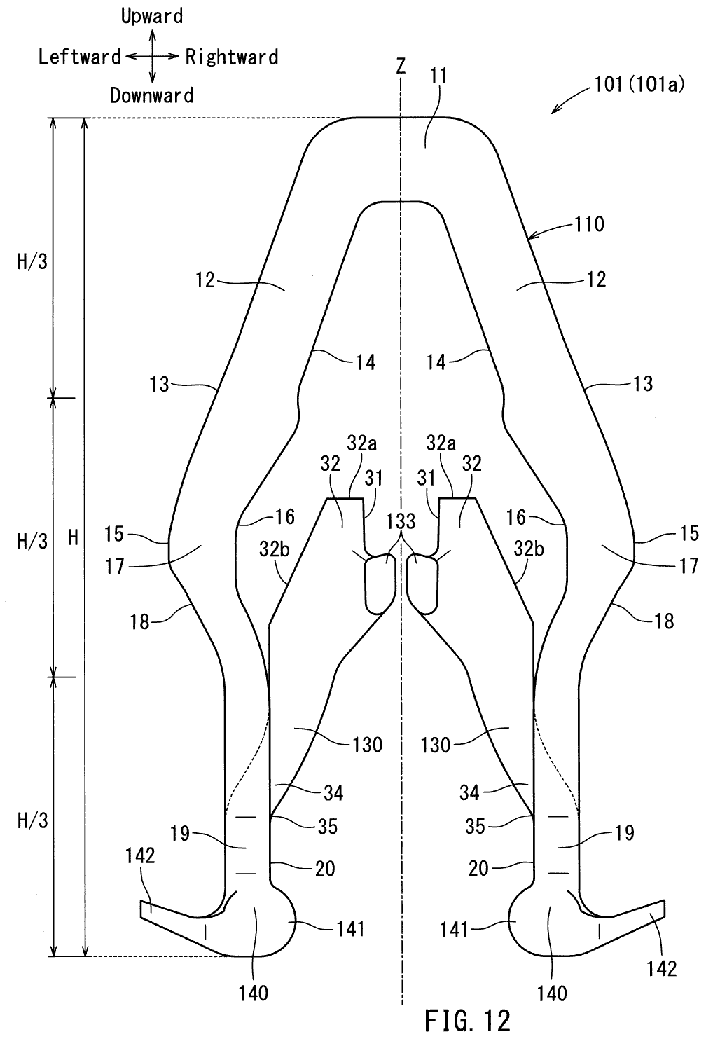

Similar to the first embodiment, the inner legs 130 are connected to the connecting members 140 at the proximal end portions 34. However, as shown in FIGS. 11 and 12, unlike the first embodiment, the proximal end portions 34 are connected to the connecting members 140 and not to the inner projections 141. Therefore, as shown in FIG. 12, the proximal end portions 34 of the inner legs 130 are positioned such that the inner surfaces 35 thereof are aligned or flush with the inside faces 20 of the root portions 19 of the leg main portions 12.

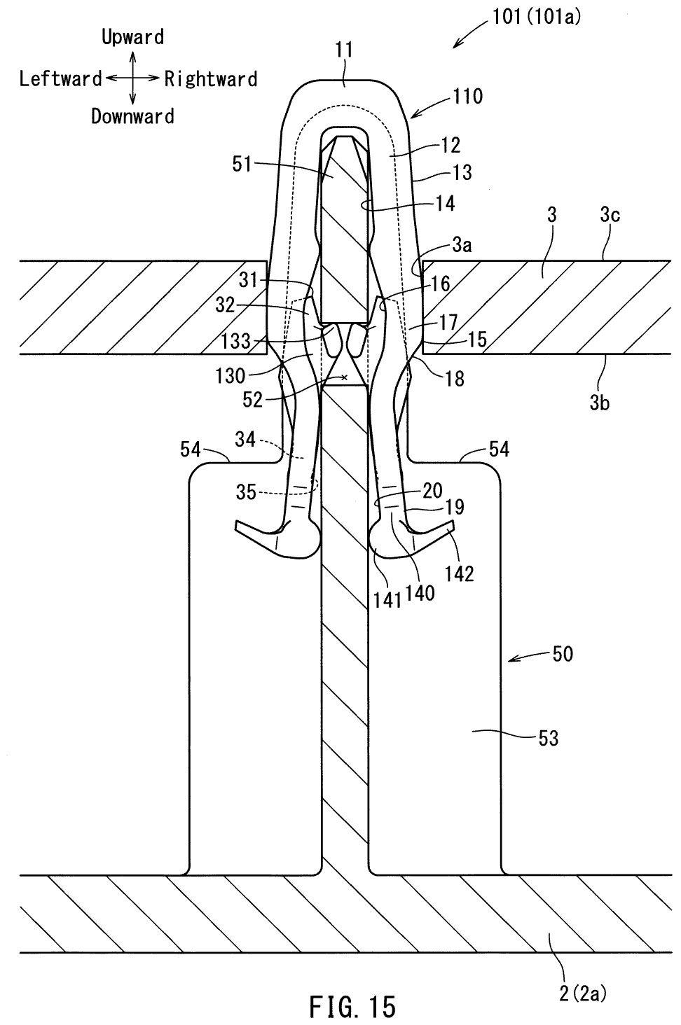

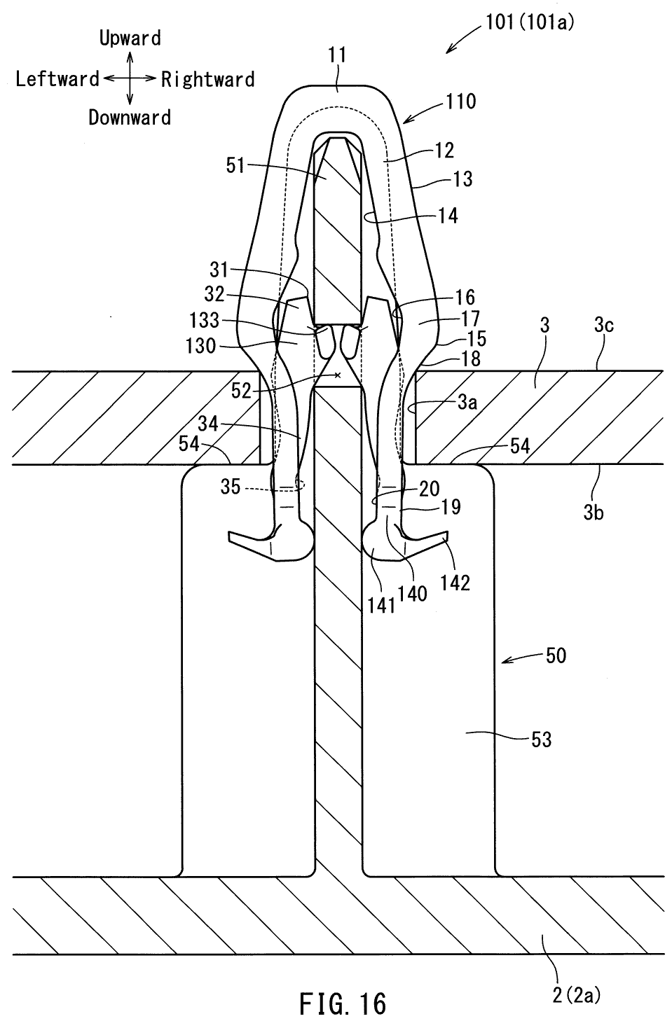

Next, a method of attaching the attaching article 2 to the object member 3 using the clip 101 and detaching the attaching article 2 from the object member 3 will now be described in detail with reference to FIGS. 15 and 16.

First, the clip main body 101a is coupled to the coupling portion 51 of the attachment base 50 with the engagement projections 133 engaging the engagement slot 52 formed in the coupling portion 51 in the substantially same manner as the clip main body 1a of the first embodiment. Thus, the clip main body 101a can be connected to the attachment base 50 of the attaching article 2.

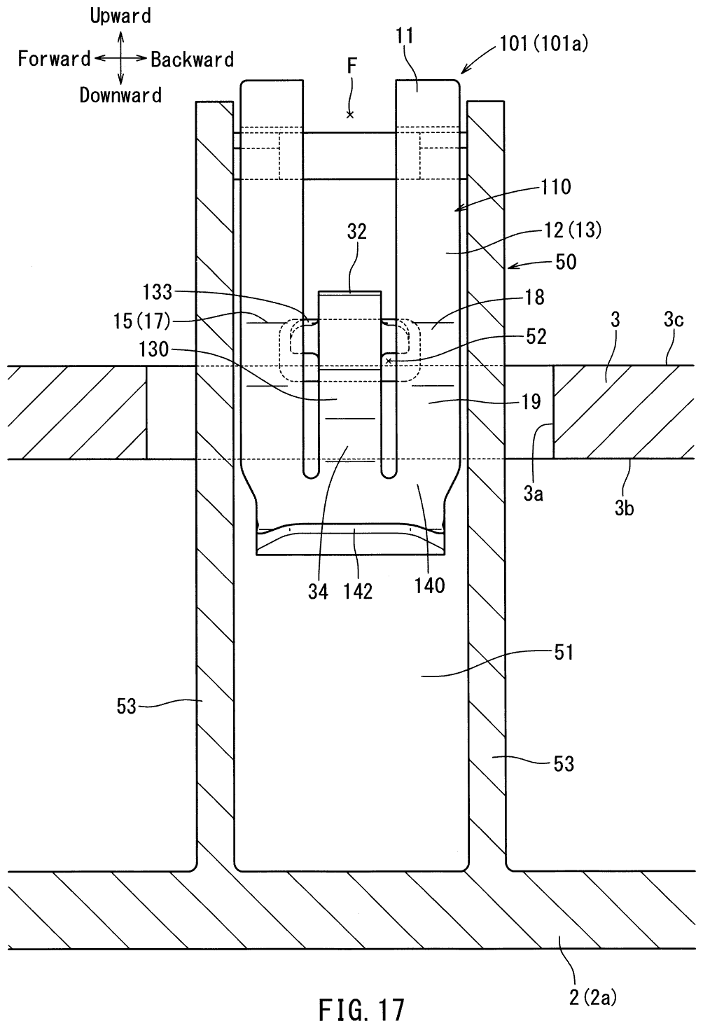

Thereafter, similar to the first embodiment, the clip main body 101a connected to the attachment base 50 of the attaching article 2 is pushed into the attaching hole 3a formed in the object member 3 at the head portions 11 of the outer legs 110. As a result, as shown in FIG. 15, the clip main body 101a may be progressively inserted into the attaching hole 3a while the leg main portions 12 of the outer legs 110 are elastically flexed inward due to contact of the outer surfaces 13 of the leg main portions 12 with the outer surface-side periphery (not labeled) of the attaching hole 3a. Subsequently, when the clip main body 101a is further pushed into the attaching hole 3a until the stopper portions 54 formed in the guide portions 53 of the attaching base 50 contact the outer surface 3b of the object member 3, the engagement portions 17 formed in the leg main portions 12 pass through the attaching hole 3a. As a result, as shown in FIG. 16, the clip main body 101a may be connected to the object member 3. Thus, the attaching article 2 may be attached to the object member 3 via the clip main body 101a, which may be referred to as a normal use condition of the clip 101 (FIGS. 16 and 17).

As shown in FIG. 16, in the normal use condition of the clip 101, similar to the inner projections 41 of the first embodiment, the inner projections 141 formed in the connecting members 140 may be pressed to the coupling portion 51 of the attachment base 50. Therefore, the inner legs 130 may be prevented from being excessively deformed.

Conversely, in order to detach or remove the attaching article 2 from the object member 3, the attaching article 2 is simply pulled such that a certain degree of extraction force can be applied to the clip main body 101a. Due to the extraction force applied to the clip main body 101a, the clip main body 101a may be withdrawn from the attaching hole 3a. As a result, the attaching article 2 can be removed from the object member 3.

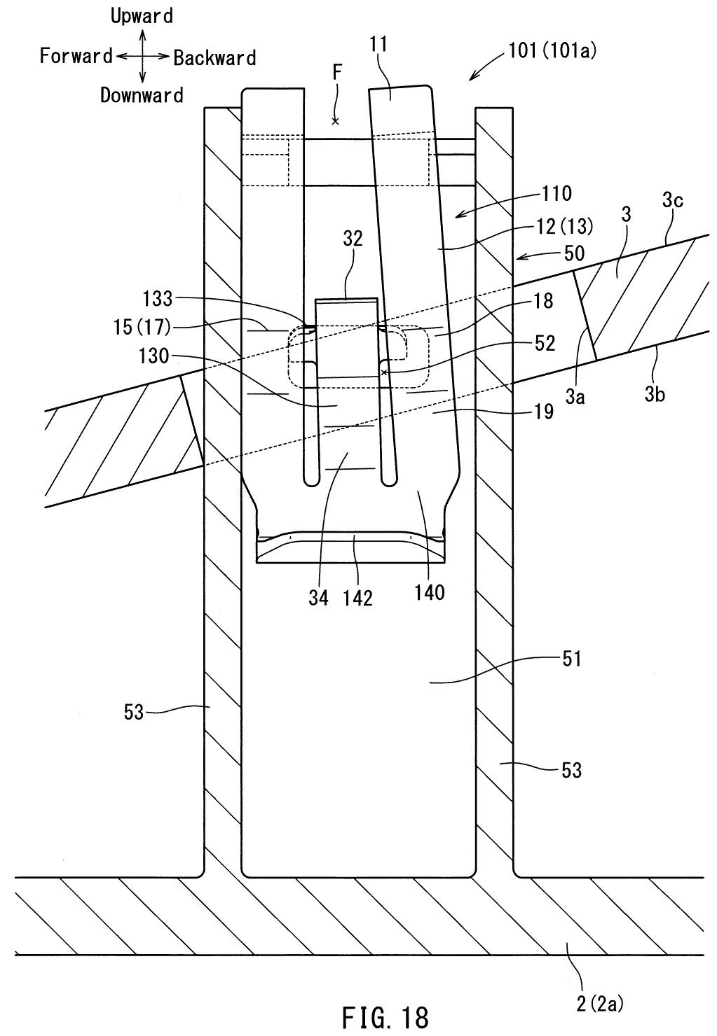

Further, in the normal use condition of the clip 101 (FIG. 17), when the attaching article 2 is inclined relative to the object member 3 in the front-back direction (FIG. 18), the clip main body 101a may be inclined relative to the object member 3 (which may be referred to as an inclined use condition of the clip 101). Consequently, similar to the front and back outer legs 10 of the first embodiment, the front and back outer legs 110 may be inclined relative to the attaching hole 3a, so that engagement positions of the engagement surfaces 18 of the engagement portions 17 with the inner surface-side periphery (not labeled) of the attaching hole 3a may be obliquely moved or displaced upward. However, similar to the clip main body 1a of the first embodiment, in the clip main body 101a, the head portions 11 of the front and back outer legs 110 are not connected to each other. That is, the clip main body 101a is configured such that the front and back outer legs 110 may freely elastically flex within the space F in the front-back direction independently from each other. Therefore, as shown in FIG. 18, when the clip main body 101a is inclined relative to the object member 3, the engagement surfaces 18 of the engagement portions 17 of one of the outer legs 110 may move or slide along the inner surface-side periphery of the attaching hole 3a of the object member 3 while elastically flexing or deforming one of the outer legs 110 relative to the other of the outer legs 110 in the front-back direction.

As a result, similar to the first embodiment, displacement of the engagement positions of the engagement surfaces 18 with the inner surface-side periphery (not labeled) of the attaching hole 3a may substantially be controlled or compensated. Therefore, engagement amounts of the engagement surfaces 18 with the inner surface-side periphery of the attaching hole 3a may be prevented from being significantly changed or reduced. That is, engagement forces of the engagement surfaces 18 against the inner surface-side periphery of the attaching hole 3a may be prevented from being significantly reduced. As a result, a retention force of the clip 101 in the inclined use condition of the clip 101 (which may be referred to as an oblique retention force of the clip 101) may be prevented from being significantly reduced relative to a retention force of the clip 101 in the normal use condition of the clip 101 (which may be referred to as a normal retention force of the clip 101). In this embodiment, similar to the first embodiment, the oblique retention force of the clip 101 may be reduced at a reduction rate of approximately 30% relative to the normal retention force of the clip 101.

Further, in the first and second embodiments, the attaching article 2 (the attachment base 50) and the object member 3 is inclined relative to each other in the front-back direction. As a result, the clip main body 1a, 101a is inclined relative to the object member 3. However, even when the attachment base 50 is inclined relative to the attaching article 2, the clip main body 1a, 101a may be inclined relative to the object member 3.

Representative examples of the present disclosure have been described in detail with reference to the attached drawings. This detailed description is merely intended to teach a person of skill in the art further details for practicing preferred aspects of the present disclosure and is not intended to limit the scope of the disclosure. Only the claims define the scope of the claimed disclosure. Therefore, combinations of features and steps disclosed in the foregoing detail description may not be necessary to practice the disclosure in the broadest sense, and are instead taught merely to particularly describe detailed representative examples of the disclosure. Moreover, the various features taught in this specification may be combined in ways that are not specifically enumerated in order to obtain additional useful embodiments of the present disclosure.

What is claimed is:

1. A clip comprising a clip main body, wherein clip main body is configured to be coupled to a coupling portion of an attachment base formed in an attaching article and is configured to be inserted into an attaching hole formed in the object member, the clip main body comprising:
a pair of substantially V-shaped outer legs oppositely positioned in a front-back direction and having head portions and first and second proximal end portions,
a pair of inner legs positioned between the pair of outer legs and having head portions and proximal end portions, and
a pair of connecting members,
wherein the first and second proximal end portions of the outer legs are respectively connected to each other via the connecting members in the front-back direction in such a manner that the outer legs are allowed to flex in the front-back direction,
wherein the proximal end portions of the inner legs are respectively connected to the connecting members such that the inner legs are positioned laterally opposite to each other,
wherein the outer legs respectively include engagement portions configured to engage the attaching hole of the object member, and
wherein the inner legs respectively include engagement projections configured to be coupled to the coupling portion of the attachment base.

2. The clip described in claim 1, wherein the outer legs are positioned at an interval, thereby forming a space therebetween, which allows the outer legs to elastically flex relative to each other in the front-back direction in a condition in which the clip main body is inserted into the attaching hole formed in the object member.

3. The clip described in claim 2, wherein the outer legs are configured such that when the outer legs elastically flex due to inclination of the clip main body relative to the attaching hole, the outer legs interfere with the inner legs.

4. The clip described in claim 3, wherein the outer legs are configured to be elastically flexed by the attaching hole of the object member so as to be overlapped with the inner legs in the front-back direction when the clip main body is inserted into the attaching hole.

5. The clip described in claim 4, wherein the inner legs are configured such that the distal end portions thereof are positioned inside relative to outer surfaces of the outer legs in the condition in which the clip main body is inserted into the attaching hole.

6. The clip described in claim 1, wherein the proximal end portions of the inner legs are positioned such that inner surfaces thereof are projected toward an axial line of the clip main body relative to inside faces of the first and second proximal end portions of the outer legs, and wherein the connecting members include inner projections to which the proximal end portions of the inner legs are connected.
